(19) United States
(12) Patent Application Publication
(10) Pub. No.: US 2022/0343343 A1
(43) Pub. Date: Oct. 27, 2022

(54) Method for Managing Item Shortage and an Apparatus for the Same

(71) Applicant: Coupang Corp., Seoul (KR)

(72) Inventors: Wei Wei, Seoul (KR); Ping Yin, Seoul (KR); Soo Kyung Choi, Seoul (KR); Timothy Wolfgang Schoenharl, Seoul (KR)

(73) Assignee: Coupang Corp., Seoul (KR)

(21) Appl. No.: 17/393,925

(22) Filed: Aug. 4, 2021

(30) Foreign Application Priority Data
Apr. 27, 2021 (KR) 10-2021-0054322

(51) Int. Cl. G06Q 30/02; G06Q 10/08

(52) U.S. Cl. CPC G06Q 30/0201; G06Q 10/087

(57) ABSTRACT

Provided is a method of providing information related to an item shortage, the method including confirming information on an item of which a shortage occurs in a fulfillment center, confirming a cause of an item shortage based on the information on the item, and providing information indicating the cause of the item shortage.

### TECHNICAL FIELD

Example embodiments of the present disclosure relate to a method of providing information related to an item shortage and an apparatus for providing the same, and more particularly, to a method and apparatus for analyzing a cause of an item shortage using information on the item and providing information indicating actions to prevent a situation in which the shortage occurs.

### DESCRIPTION OF THE RELATED ART

With the development of electronic technology, e-commerce has taken its place as a form of shopping. Customers may purchase items online without going to shopping malls or markets directly, and the items purchased online are delivered to delivery destinations requested by the customers.

A logistics information management system for e-commerce services as described above may operate a plurality of fulfillment centers in order to provide more effective services, and may manage information on each fulfillment center. For example, when an order for an item is requested, the logistics information management system determines fulfillment centers to process the orders in consideration of characteristics of the order (for example, delivery destination, stock of fulfillment centers, or the like) and may assign orders to the determined fulfillment centers.

For reference, related art documents such as KR100932262B1 may be referred to.

### DISCLOSURE OF THE INVENTION

An aspect is to accurately analyze a cause of an item shortage when the item shortage occurs and provide information indicating necessary actions to prevent a situation in which the item shortage occurs in the future.

The technical goals to be achieved by some example embodiments of the present disclosure are not limited to the technical goals described above, and other technical goals may be inferred from some following example embodiments.

According to an aspect, there is provided a method of providing information including: at least one of confirming information on an item of which a shortage occurs in a fulfillment center, the information on the item including an order status of the item; confirming a cause of an item shortage based on the information on the item; and providing information indicating the cause of the item shortage.

The cause of the item shortage may be at least one of a first shortage cause related to obsolescence by a vendor, a second shortage cause related to an order status of the item, a third shortage cause related to the fulfillment center, a fourth shortage cause related to a nature of the item, a fifth shortage cause due to a sales amount of the item, and a sixth shortage cause due to a small order quantity of the item.

The confirming of the cause of the item shortage may include confirming the first shortage cause to the sixth shortage cause in a confirmation order determined according to a priority.

The confirming of the cause of the item shortage may further include: confirming information indicating a vendor of the item from the information on the item; and determining the cause of the item shortage as the first shortage cause when the vendor has discontinued (so called obsoleted) the item.

The second shortage cause related to the order status of the item may be determined based on information indicating the order status of the item acquired from the information on the item.

The confirming of the cause of the item shortage may further include determining the cause of the item shortage as the second shortage cause when the order status of the item for a day before a first date when the item shortage occurs is a discontinued status (obsolete status).

The confirming of the cause of the item shortage may further include determining the cause of the item shortage as the second shortage cause when the order status of the item for a second date before a specific period from a first date when the item shortage occurs is a discontinued status (obsolete status), and a scheduled receiving date for an order after the second date is after the first date.

The confirming of the cause of the item shortage may further include determining the cause of the item shortage as the second shortage cause when the order status of the item for a second date before a specific period from a first date when the item shortage occurs is a discontinued status (obsolete status), and there is no order for the item after the second date.

The discontinued status (obsolete status) may be a discontinued status based on the item being a seasonal item or a discontinued status based on the item being an item related to a social issue.

The third shortage cause includes a first shortage sub-cause indicating a shortage due to stock adjustment of the item and a second shortage sub-cause indicating a shortage related to a stowing delay of the item in the fulfillment center.

The information on the item may include information indicating whether stock of the item has been adjusted within a specific period, and the confirming of the cause of the item shortage may further include determining the cause of the item shortage as the first shortage sub-cause when stock of the item has been adjusted within the specific period.

The information on the item may include a stow time of the item in the fulfillment center and an unloading time of the item in the fulfillment center, and the confirming of the cause of the item shortage may further include determining the cause of the item shortage as the second shortage sub-cause when a difference between the stow item and the unloading time is a specific time or more.

The information on the item may include a first sales amount indicating a sales amount of the item for a first period, and a second sales amount indicating a sales amount of the item for a second period after the first period, and the confirming of the cause of the item shortage may further include determining whether the cause of the item shortage is the fifth shortage cause by calculating a ratio of the second sales amount to the first sales amount.

The information on the item may further include a summed order quantity of the item, an order reduction amount of the item due to a capacity of the fulfillment center, and a fill rate of a supplier for the item, and the confirming of the cause of the item shortage may further include confirming whether the cause of the item shortage is the sixth shortage cause due to an order quantity and the fill rate of the item.

The method may further include confirming a remaining acceptable quantity of the fulfillment center when the cause of the item shortage is the sixth shortage cause and determining an appropriate order quantity of the item based on the remaining acceptable quantity and the sales amount of the item.

The information on the item may include the number of returns of the item and a received amount of the item within a specific period, and the cause of the item shortage may include a seventh shortage cause which is a shortage cause due to a quality defect of the item.

The confirming of the cause of the item shortage may further include determining the cause of the item shortage as the seventh shortage cause when the number of returns of the item within the specific period is a specific number of times or more and the number of returns of the item is greater than or equal to a specific ratio of the received amount of the item.

The method may further include reporting the information indicating the cause of the item shortage to a subject corresponding to the confirmed item shortage cause.

According to various example embodiments, it is possible for an electronic apparatus to minimize an occurrence rate of item shortages by analyzing a cause of an item shortage and reporting the shortage cause to related departments or the like, thereby reducing unnecessary expenditure and consumer dissatisfaction.

According to various example embodiments, it is possible for an electronic apparatus to quickly eliminate a shortage cause when the shortage cause occurs due to obsolescence by a vendor.

According to various example embodiments, it is possible for an electronic apparatus to store an order status of an item by period and confirm whether the cause of the item shortage is due to the order status of the item by using the order status of the item stored by period, thereby clearly identifying whether a problem has occurred during an order or in an order cycle.

According to various example embodiments, it is possible for an electronic apparatus to carefully analyze the shortage cause by combining methods for analyzing various shortage causes in a specific order or a preset order, and confirming the shortage causes according to a priority, thereby preventing item shortages in the future.

### BRIEF DESCRIPTION OF THE DRAWINGS

FIG. 1 illustrates an example of internal components of an electronic apparatus according to example embodiments.

FIG. 2 is a flowchart illustrating an example of a method of providing information related to an item shortage according to example embodiments.

FIG. 3 illustrates an example of item shortage causes according to example embodiments.

FIG. 4 illustrates an example of the cause of the item shortages according to example embodiments.

FIG. 5 illustrates an example of an operation of confirming a shortage cause due to obsolescence by a vendor by the electronic apparatus according to the example embodiments.

FIG. 6 illustrates an example of an operation of confirming a shortage cause due to a state in which an order status of an item is inactive by the electronic apparatus according to the example embodiments.

FIG. 7 illustrates an example of an operation of confirming the shortage cause due to the state in which the order status of the item is inactive by the electronic apparatus according to the example embodiments.

FIG. 8 illustrates an example of an operation of confirming a shortage cause due to an andon status of an item by the electronic apparatus according to the example embodiments.

FIG. 9 illustrates an example of an operation of confirming a shortage cause due to an order status of an item by the electronic apparatus according to the example embodiments.

FIG. 10 illustrates an example of an operation of confirming a shortage cause due to a defect in a fulfillment center or the like by the electronic apparatus according to example embodiments.

FIG. 11 illustrates an example of an operation of confirming a shortage cause due to a small order amount by an electronic apparatus according to example embodiments.

FIG. 12 illustrates an example of an operation of confirming a shortage cause due to a small order quantity according to a capacity of the fulfillment center according to example embodiments.

FIG. 13 illustrates an example of an operation of confirming a shortage cause due to a sales amount of an item by the electronic apparatus according to the example embodiments.

FIG. 14 illustrates an example of an operation of confirming a shortage cause due to a supplier by the electronic apparatus according to the example embodiments.

FIG. 15 illustrates examples of an operation of confirming a shortage cause due to a lack of item delivery by a supplier by the electronic apparatus according to example embodiments.

FIG. 16 illustrates an example of a configuration diagram of the electronic apparatus according to example embodiments.

### DETAILED DESCRIPTION OF THE INVENTION

Hereinafter, example embodiments of the present disclosure will be described in detail with reference to the accompanying drawings.

In describing the example embodiments, description of technical content that is well known in the technical field to which the present disclosure pertains and is not directly related to the present disclosure will be omitted. This is to more clearly convey the gist of the present disclosure without ambiguity by omitting unnecessary descriptions.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods of accomplishing them will become apparent from example embodiments to be described in detail below with reference to the accompanying drawings. However, the present disclosure is not limited to some example embodiments to be described below but may be implemented in various different forms, and these example embodiments will be provided only in order to make the present disclosure complete and allow those skilled in the art to completely recognize the scope of the present disclosure, and the present disclosure will be defined by the scope of the claims. Throughout the specification, like reference numerals denote like elements.

In this case, it will be appreciated that each block of a processing flowchart and combinations of the flowcharts may be executed by computer program instructions. Since these computer program instructions may be installed in a processor of a general computer, a special computer, or other programmable data processing apparatuses, these computer program instructions executed through the process of the computer or the other programmable data processing apparatuses create a unit for performing functions described in a block(s) of the flowchart. Since these computer program instructions may also be stored in a computer usable or computer readable memory of a computer or other programmable data processing apparatuses in order to implement the functions in a particular way, the computer program instructions stored in the computer usable or computer readable memory may also produce manufacturing articles including an instruction unit for performing the functions described in a block(s) of the flowchart. Since the computer program instructions may also be installed in the computer or the other programmable data processing apparatuses, the instructions perform a series of operation steps on the computer or the other programmable data processing apparatuses to create processes executed by the computer to run the computer or the other programmable data processing apparatuses, it may be possible to provide steps for performing the functions described in a block(s) of the flowchart.

In addition, each block may indicate some of modules, segments, or code including one or more executable instructions for executing a specific logical function (specific logical functions). Further, it is to be noted that functions mentioned in the blocks may occur in any sequence in some alternative example embodiments. For example, two blocks that are shown consecutively may in fact be simultaneously performed or performed in a reverse sequence depending on corresponding functions.

In this case, the term “˜ unit” used in these example embodiments refers to software or hardware components such as a field programmable gate array (FPGA) or an application specific integrated circuit (ASIC), and the “˜ unit” performs certain roles. However, “˜ unit” is not limited to software or hardware. A “˜ unit” may be configured to be in an addressable storage medium or may be configured to reproduce one or more processors. Therefore, as an example, a “˜ unit” includes components such as software components, object-oriented software components, class components and task components, processes, functions, attributes, procedures, subroutines, segments of program code, drivers, firmware, microcode, circuit, data, a database, data structures, tables, arrays, and variables. Components and functions provided within “˜ units” may be combined into a smaller number of components and “˜ units” or further separated into additional components and “˜ units.” Furthermore, components and “˜ units” may be implemented to reproduce one or more central processing units (CPUs) in a device or a security multimedia card.

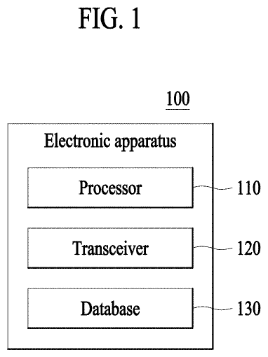

FIG. 1 is a diagram illustrating an example of internal components of an electronic apparatus according to example embodiments.

Referring to FIG. 1, internal components of an electronic apparatus 100 are not limited only to the illustrated components. The electronic apparatus 100 may include at least one of a processor 110, a transceiver 120, and a memory 130.

The processor 110 may process a series of operations for performing a method of providing information related to an item shortage according to various example embodiments of the present disclosure. The processor 110 may control other components of the electronic apparatus 100. Meanwhile, in an example embodiment, “product” may be used as a term referring to a specific item, and an item may be sold to a user in a service related to the electronic apparatus 100.

The processor 110 may confirm detailed information on a first product in response to a request on a first page for the first product. When the processor 110 confirms through the memory 130 whether the first product is included in a specific category, the processor 110 may confirm at least one second product corresponding to the specific category. The processor 110 may confirm at least one attribute list corresponding to the specific category, and the attribute list may be stored in advance in the memory 130 or may be received from the outside through the transceiver 120. The processor 110 may provide the first page on a display of the electronic apparatus 100. The first page may include a first part in which the detailed information on the first product is provided, a second part in which first attribute information of the first product corresponding to the attribute list is provided, and a third part in which second attribute information of at least one second product corresponding to the attribute list is provided.

The transceiver 120 may perform a function of transmitting information stored in the memory 130 of the electronic apparatus 100 or information processed by the processor 110 to other devices or a function of receiving information from the other devices for the electronic apparatus 100.

The memory 130 has a data structure implemented in a predetermined storage space of the electronic apparatus 100, and thus functions such as storing, searching, deleting, editing, or adding data may be freely performed. For example, the memory 130 may include fields or components for processing functions such as storing, searching, deleting, editing, or adding data. The memory 130 may store data related to performing an information providing method by the electronic apparatus 100. For example, the memory 130 may store instructions or data for an execution operation of the processor 110.

The memory 130 according to some example embodiments may include a database for storing information on items, and the like.

The electronic apparatus 100 according to some example embodiments may perform the method of providing information related to an item shortage according to example embodiments described below. The electronic apparatus 100 may be referred to as, for example, an apparatus for managing an item shortage. Meanwhile, the item shortage in the overall example embodiments may include a case in which the item is not in stock in one fulfillment center or a plurality of fulfillment centers. In addition, a stock status of an item in which an item corresponding to an order cannot be provided in one or more fulfillment centers may be determined as a shortage. Further, depending on the settings, the electronic apparatus may also determine a case in which the stock status of the item falls below a safety stock as a shortage. In this way, when a shortage occurs, it is possible to provide effective information so that an unwanted shortage does not occur by acquiring information related to an item in which a shortage has occurred, identifying the shortage cause, and providing the identified shortage cause to a user. Accordingly, it is necessary for an electronic apparatus to effectively collect information on an item, identify a main shortage cause when the shortage has occurred, and provide the identified main cause to a user. In addition, item-related information may be received from a fulfillment center or other electronic apparatuses in procedures such as ordering, receiving, and storage. In addition, the cause of the item shortage may be determined based on information for changing an item-related setting according to information input to the electronic apparatus.

In addition, an interface described in the present specification may be variously interpreted as a configuration of hardware for receiving an input signal from a user or an icon, a widget, a button, a slide bar, a progress bar, a touch area, or the like implemented in software.

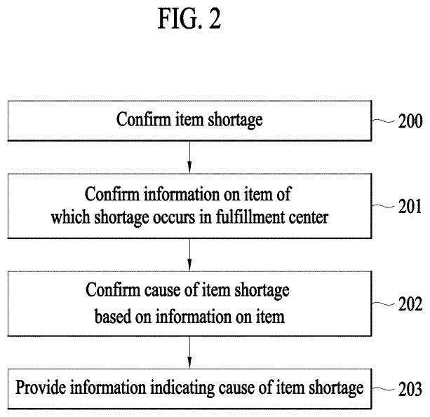

FIG. 2 is a flowchart illustrating an example of a method of providing information related to an item shortage according to the example embodiments.

The method of providing information related to an item shortage according to some example embodiments illustrated in FIG. 2 may be performed by the electronic apparatus according to the example embodiments. The electronic apparatus may be, for example, the electronic apparatus 100 in FIG. 1. The electronic apparatus according to some example embodiments may perform some or all procedures of operations 200 to 203 illustrated in FIG. 2.

An item may include, for example, a product, goods, or the like that have been ordered from a supplier and delivered by the supplier, and may be stored in at least one fulfillment center (fulfillment center). Upon receiving an item from a supplier, the fulfillment center may unload the item and stow the item at a specific location within the fulfillment center. The fulfillment center may store items for a specific period or longer. When a purchaser purchases the item, the item may be released from a specific fulfillment center and shipped to the purchaser.

Meanwhile, when an item is not sufficiently stored in a fulfillment center, the item is not in a fulfillment center, or there is a cause for which an item cannot be sold or shipped due to a problem with the item, an item shortage may occur. The item shortage may represent a state in which there is no stock of an item in a fulfillment center on a day just before an item is sold. Furthermore, when a shortage occurs due to a continuous failure to control supply and demand of an item, consumers may be dissatisfied, and as a result, it is necessary to prevent item shortages.

Accordingly, the electronic apparatus according to some example embodiments may analyze a cause of an item shortage when the item shortage occurs, and take possible actions in response to the shortage cause. Accordingly, the electronic apparatus according to some example embodiments may perform at least one of operations 200 to 203 illustrated in FIG. 2. Meanwhile, in the example embodiment, the electronic apparatus may confirm a shortage cause selected according to a priority among the confirmed shortage causes, determine a recipient corresponding thereto, and provide the shortage cause to the determined recipient. In addition, at least one of future order timing and quantity may be adjusted based on the shortage cause.

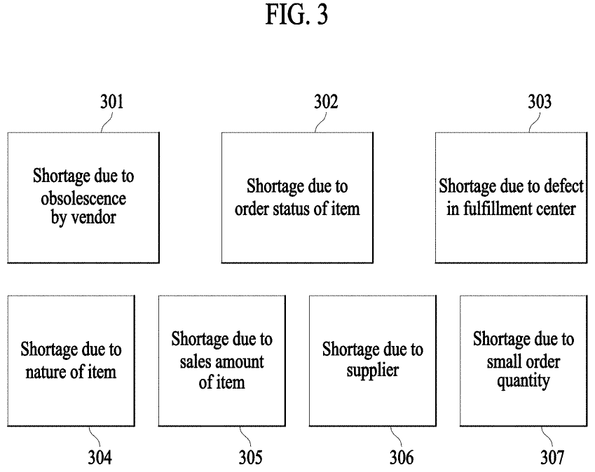

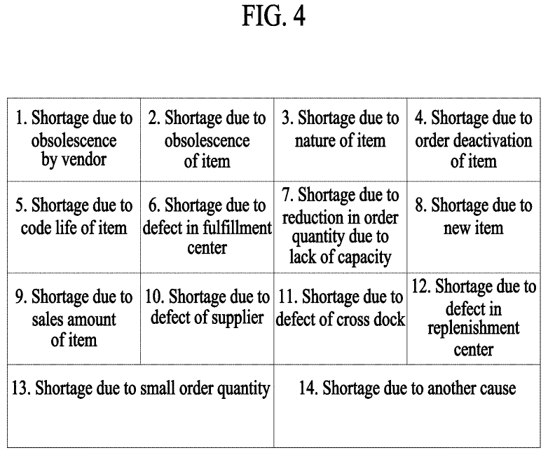

Referring to operation 200 in FIG. 2, the electronic apparatus according to some example embodiments may confirm the item shortage. Item shortage causes may be various. Examples of the cause of the item shortages will be described in detail with reference to FIGS. 3 and 4. The electronic apparatus according to some example embodiments may confirm shortages for each item and analyze a shortage cause for each item.

Referring to operation 201 in FIG. 2, the electronic apparatus according to some example embodiments may confirm information on an item of which a shortage occurs in a fulfillment center. The electronic apparatus according to some example embodiments may store information on items for each item. That is, when the electronic apparatus confirms that a shortage has occurred for a specific item, the electronic apparatus confirms the information on the item.

The information on the items may include, for example, a name of an item, a supplier that supplies an item, a sales amount of items for each period, information on a fulfillment center in which an item is stored, information on a supplier (that is, information indicating a vendor of an item) when an item is ordered from and supplied by a supplier, and information on an order (for example, an order cycle, an order quantity for each order, or the like).

Referring to operation 202 in FIG. 2, the electronic apparatus according to some example embodiments may confirm a cause of an item shortage based on the information on the item. Item shortage causes may be various, and the electronic apparatus may, for example, confirm one of the causes illustrated in FIGS. 3 and 4 as a cause of an item shortage. In addition, according to an example embodiment, it is possible to confirm the shortage cause according to a priority based on the information on the item of which there is a shortage.

Referring to operation 203 in FIG. 2, the electronic apparatus according to some example embodiments may confirm a cause of an item shortage from operation 202 and provide information indicating the cause of the item shortage.

The electronic apparatus according to some example embodiments may further perform reporting the information including the cause of the item shortage. The electronic apparatus according to some example embodiments may report the information indicating the cause of the item shortage to a subject corresponding to the confirmed item shortage cause. In other words, the electronic apparatus may change a subject of reporting according to the shortage cause.

According to various example embodiments, it is possible for the electronic apparatus to minimize an occurrence rate of item shortages by analyzing the cause of the item shortage and reporting the shortage cause to related departments or the like, thereby reducing unnecessary expenditure and consumer dissatisfaction.

FIG. 3 is a diagram illustrating an example of item shortage causes according to the example embodiments.

The cause of the item shortages according to some example embodiments illustrated in FIG. 3 may be the cause(s) of item shortages described in FIG. 2. The cause of the item shortage according to some example embodiments may include, for example, at least one of a shortage cause 301 due to obsolescence by a vendor, a shortage cause 302 due to an order status of an item, a shortage cause 303 due to a defect in a fulfillment center, a shortage cause 304 due to a nature of an item, a shortage cause 305 due to a sales amount of an item, a shortage cause 306 due to a supplier, and a shortage cause 307 due to a small order quantity.

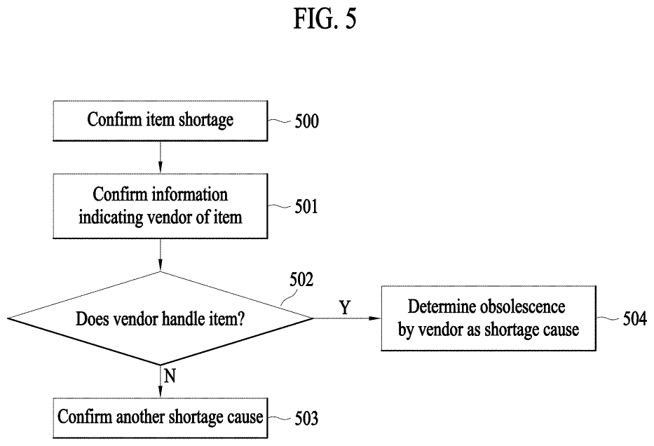

The shortage cause 301 due to obsolescence by a vendor may mean, for example, that the cause of the item shortage is due to obsolescence by a supplier that supplies an item, that is, a vendor. For example, when a supplier supplying a specific item has recently changed to a discontinued status (obsolete status), and a shortage occurrence date is later than a date when an item was most recently received from the supplier, the cause of the item shortage may be the shortage cause due to obsolescence by the vendor. The shortage cause 301 due to obsolescence by a vendor may be confirmed, for example, through some or all of the operations of the electronic apparatus illustrated in FIG. 5.

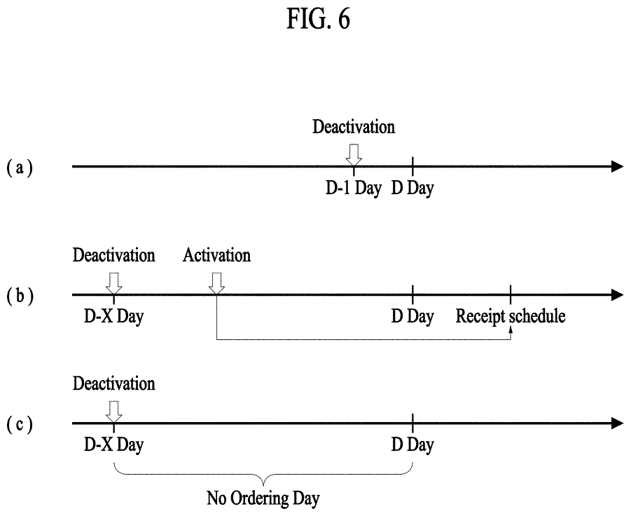

The shortage cause 302 due to the order status of the item may mean, for example, that the cause of the item shortage is a shortage due to obsolescence of an item. The shortage due to the obsolescence of the item may include a case in which an item becomes discontinued (obsolete) with a supplier and thus is not handled, a case in which an item is a seasonal item and thus is temporarily not handled, a case in which an item is temporarily not handled due to a need to negotiate with a supplier for the item, a case in which an item is related to a social issue and thus is temporarily not handled, or the like. The shortage cause 302 due to the order status of the item may be confirmed, for example, through some or all of the operations of the electronic apparatus illustrated in FIGS. 6 to 9.

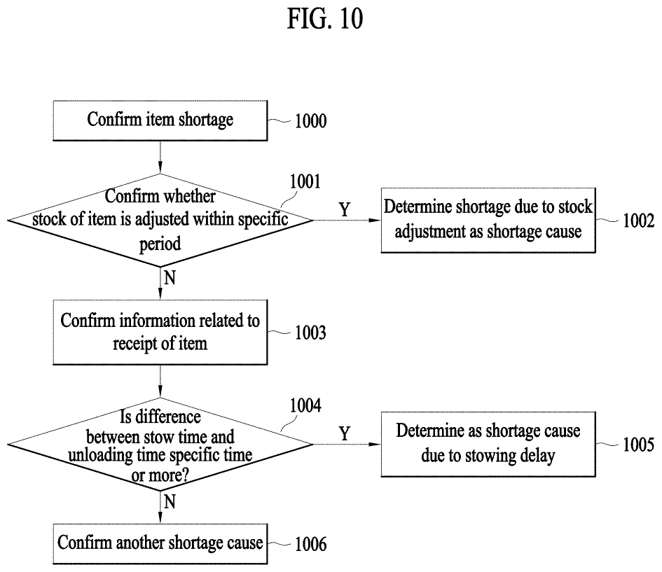

The shortage cause 303 due to a defect in a fulfillment center or the like may mean, for example, that a shortage occurs due to a defect in a fulfillment center storing an item. For example, the shortage cause 303 due to a defect in a fulfillment center or the like may include a case in which a shortage occurs due to neglect and the item is not stowed, a case in which an item shortage occurs due to a stock adjustment of an item within a fulfillment center, a case in which an item shortage occurs due to an unload delay, a case in which an item shortage occurs due to a stowing delay, or the like. The shortage cause 302 due to the order status of the item may be confirmed, for example, through some or all of the operations of the electronic apparatus illustrated in FIG. 10.

According to the example embodiments, the case in which the shortage occurs due to neglect and the item is not stowed may mean that the item shortage occurs because an item is received in a fulfillment center but neglected for a specific time or more (for example, 72 hours or the like) without being stowed, and thus may not be confirmed or is processed as being lost or scrapped.

The shortage cause 304 due to the nature of the item may be, for example, a case in which the item shortage occurs due to the nature of the item. For example, there may be cases in which a shortage occurs because an item is a food ingredient or is an item with a short code life (for example, expiration date) in which an item may be sold and thus the item has already been scrapped or sold out before being received. Alternatively, there may be cases in which a shortage occurs because an item is a new product and thus is sold out.

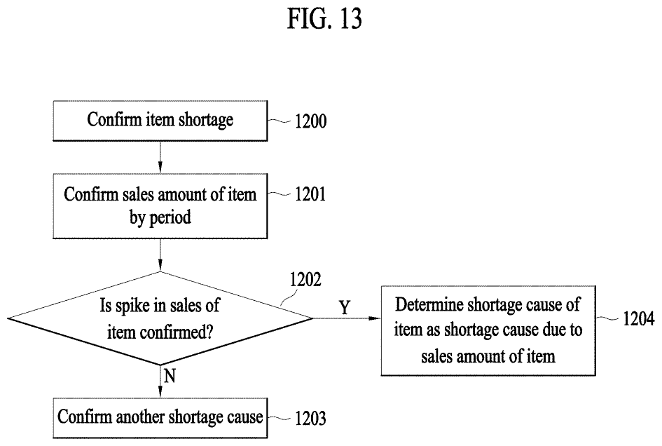

The shortage cause 305 due to the sales amount of the item may include, for example, a case in which a shortage occurs because many units of an item are sold in a short period of time or a sales amount surges temporarily and the item is out of stock, a case in which a shortage occurs because a sales amount of an item surges due to an event and the item is out of stock, or the like. The shortage cause 305 due to the sales amount of the item may be confirmed, for example, through some or all of the operations of the electronic apparatus illustrated in FIG. 13.

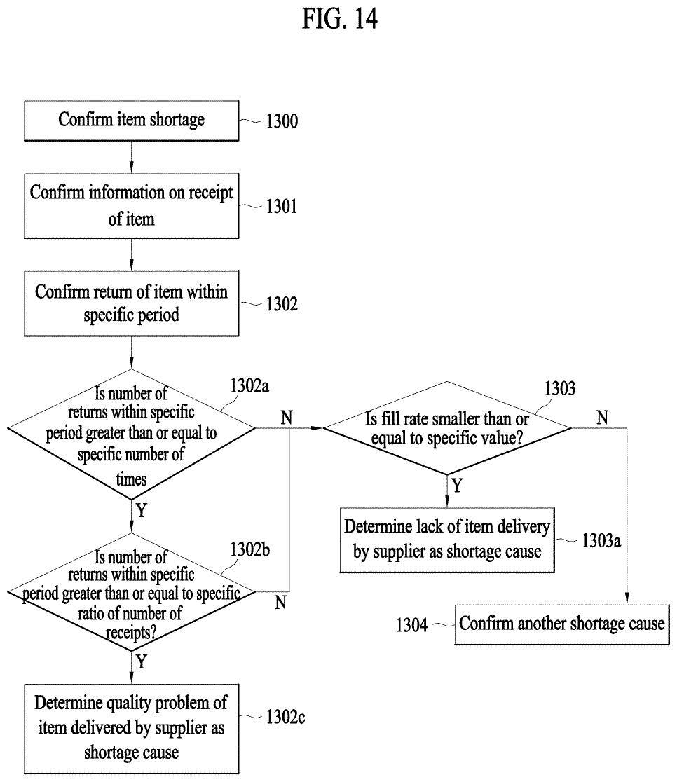

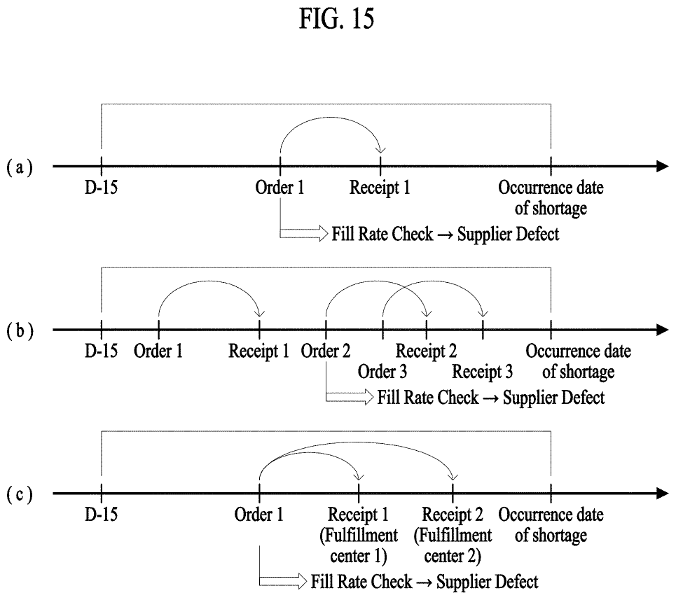

The shortage cause 306 due to the supplier may be, for example, a case in which an item shortage attributable to the supplier supplying the item occurs. The shortage cause 306 due to the supplier may include, for example, a case in which a shortage occurs because a smaller quantity of an item than a quantity that was ordered from a supplier is received, a case in which an item is supplied but cannot be sold due to a quality problem, or the like. The shortage cause 306 due to the supplier may be confirmed, for example, through some or all of the operations of the electronic apparatus illustrated in FIGS. 14 and 15.

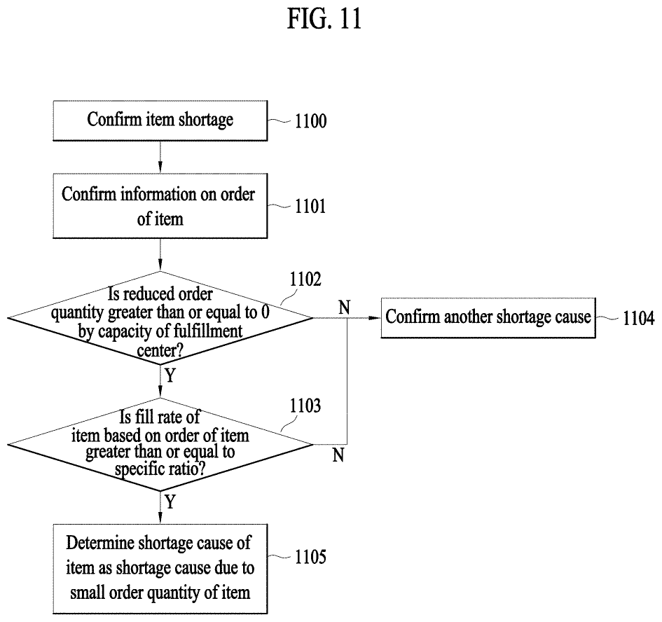

The shortage cause 307 due to the small order quantity may be, for example, a case in which a shortage occurs because an order quantity of an item is determined and ordered based on a sales amount of the item but the order is reduced due to a forecast error, capacity of a fulfillment center, or the like. The shortage cause 307 due to the small order quantity may be confirmed, for example, through some or all of the operations of the electronic apparatus illustrated in FIG. 11.

According to various example embodiments, it is possible for the electronic apparatus to minimize an occurrence rate of item shortages by analyzing the cause of the item shortage and reporting the shortage cause to related departments or the like, thereby reducing unnecessary expenditure and consumer dissatisfaction.

FIG. 4 is a diagram illustrating an example of the cause of the item shortages according to the example embodiments.

The electronic apparatus according to some example embodiments may analyze a shortage cause in the order of a shortage cause shown at the top left of the table illustrated in FIG. 4 to a shortage cause shown at the bottom right of the table illustrated in FIG. 4.

The electronic apparatus according to some example embodiments may generate a decision tree using a frequency of item shortage causes included in the table illustrated in FIG. 4, and the electronic apparatus may confirm the cause of the item shortage based on the generated decision tree in the order shown in the decision tree.

The cause of the item shortage may be confirmed by combining the order of the cause of the item shortages according to some example embodiments in a level or order unit. That is, the electronic apparatus may determine the cause of the item shortage by using a hierarchical decision tree that is hierarchically shown. Table 1 below illustrates an example of a hierarchical decision tree.

TABLE 1

| Level 1 | Level 2 |
|---|---|
| Shortage due to | Shortage due to obsolescence |
| obsolescence by vendor | by vendor |
| Shortage due to | Deactivation of order of item |
| obsolescence of item | Shortage due to seasonal item |
| | Interruption of order due to necessity |
| | of negotiation |
| | Shortage due to andon status |
| | Social issue |
| Shortage due to code | When buying period is less than code |
| life of item | life of item |
| Shortage due to defect | Shortage due to stock adjustment |
| in fulfillment center | Shortage due to stowing delay |
| | Shortage due to defect of cross dock |
| Shortage due to small | Shortage due to reduction in order quantity |
| order quantity | according to capacity of fulfillment center |
| Shortage because item | |
| is new product | |
| Shortage due to sales | Shortage due to spike sale |
| amount of item | |
| Shortage due to supplier | Due to negotiation with supplier |
| | None Delivery |
| | Short Delivery |
| Shortage due to defect in | Replenishment Center No Transfer |
| replenishment center | Replenishment Center No Transfer Request |
| | Replenishment Center Transfer Requested |

The shortage due to the code life of the item may be, for example, a case in which an item shortage occurs because a code life (i.e., a period for which the item may actually be sold) of the item is shorter than a buying period of the item. The code life may also be information determined based on an expiration date, and may be set such that products are sold for a period that is longer than a certain period based on the expiration date and determined based on the set period. Meanwhile, a sales amount of an item by period may be determined through an existing sales history, and a forecasted sales amount may also be included in the information on the item. The buying period may be, for example, a period from a time when an item is ordered to a scheduled receiving date.

The shortage due to the defect in the replenishment center may mean, for example, that an item shortage occurs due to delayed delivery, shipment, or the like of a replenishment center because an item is an item that needs to pass through the replenishment center (for example, frozen foods or the like). The item that needs to pass through the replenishment center may be received in the fulfillment center and then shipped, or the item received in the fulfillment center may be stored in and shipped from the replenishment center, and the item that needs to be shipped from the replenishment center may be an item that has been delivered insufficiently from the fulfillment center (short delivery) or has not been delivered from the fulfillment center (non-delivery). Similarly, the item to be shipped from the fulfillment center may be an item that has been delivered insufficiently from the replenishment center (short delivery) or has not been delivered from the replenishment center (non-delivery).

For example, the shortage cause due to the defect in the replenishment center may include a cause related to a first replenishment center due to non-transfer from the replenishment center, a cause related to a second replenishment center due to an error that occurred in a transfer request for the replenishment center (Replenishment Center No Transfer Request), and a cause related to a third replenishment center due to a defect that occurred during replenishment center stock transfer (Replenishment Center Transfer Requested).

The cause related to the first replenishment center may indicate the cause of the item shortage that occurred in the fulfillment center because a required quantity could not be transferred to each fulfillment center due to the lack of stock in the replenishment center. The cause related to the second replenishment center may indicate a cause of an item shortage that occurs because the replenishment center has stock of items, but a transfer procedure for transferring items to each fulfillment center by the required quantity is not performed normally. The cause related to the third replenishment center may indicate a shortage cause that occurs because the replenishment center has stock of items, and a stock transfer request is performed normally, but the stock transfer of the item is not performed normally due to another cause.

The electronic apparatus according to some example embodiments may determine the shortage cause due to the defect in the replenishment center based on an order time of an item, an order quantity of an item at the time of an order, and a quantity of an item delivered for each order. For example, the electronic apparatus according to some example embodiments may confirm whether an item has been ordered by back-calculating 21 days from a date when an item shortage occurs. The electronic apparatus may confirm information on an order of a specific number of items (for example, three items) close to an occurrence date of a shortage among order requests from 21 days before the occurrence date of the shortage to the occurrence date of the shortage. The information on the order of the item and the quantity of the item delivered to the replenishment center may be included in the information on the item according to the example embodiments.

The electronic apparatus according to some example embodiments may calculate a fill rate for an order of each item. The fill rate may represent a ratio of a quantity of items delivered to the actual replenishment center (or fulfillment center) to a quantity of items requested in the order request procedure. When an item is an item delivered to a fulfillment center via a replenishment center, the electronic apparatus according to some example embodiments may calculate each of a fill rate of an item for the replenishment center and a fill rate of an item for the fulfillment center.

The cause related to the first replenishment center according to some example embodiments may include a first sub-cause that an item shortage occurs in a fulfillment center because a replenishment center does not receive all items from a supplier, and a second sub-cause that an item shortage occurs in a fulfillment center because a replenishment center does not receive some items from a supplier. The electronic apparatus may confirm information on an order of a specific number of items (for example, three items) close to an occurrence date of shortage among order requests from 21 days before the occurrence date of the shortage to the occurrence date of the shortage, and confirm the first sub-cause as a cause of an item shortage when the replenishment center does not receive items from a supplier (for example, when the fill rate is 0). The electronic apparatus may confirm information on an order of a specific number of items (for example, three items) close to an occurrence date of a shortage among order requests from 21 days before the occurrence date of the shortage to the occurrence date of the shortage, and confirm the second sub-cause as a cause of an item shortage when the replenishment center does not receive some items from a supplier (for example, when the fill rate is 0 to 90%).

The cause related to the second replenishment center according to some example embodiments may include a third sub-cause indicating a case in which a fulfillment center incorrectly requests a transfer of an item to a replenishment center or a problem occurs during the transfer request, and a fourth sub-cause indicating a case in which an item shortage occurs because there is an error in a forecast or the like of a sales amount of an item in a fulfillment center and an appropriate amount of item cannot be presented to a replenishment center.

The cause related to the third replenishment center according to some example embodiments may include a fifth sub-cause indicating a case in which a fulfillment center incorrectly transfers an item to a replenishment center or a problem occurs, and a sixth sub-cause indicating a case in which an item shortage occurs because there is an error in a forecast or the like of a sales amount of an item in a fulfillment center and an appropriate amount of item cannot be presented to a replenishment center.

Referring to FIG. 4, a level may represent, for example, a vertical relationship of classification. For example, causes of item shortage displayed in a column of level 1 may represent a large category, and causes of item shortage displayed in a column of level 2 may represent a shortage sub-cause of a specific large category.

As illustrated in FIG. 4, the electronic apparatus according to some example embodiments may determine a specific item shortage cause as one of the shortage causes shown in level 1 and determine the specific item shortage cause as one of the shortage causes shown in level 2 by analyzing the specific shortage cause in more detail.

According to various example embodiments, it is possible for the electronic apparatus to minimize an occurrence rate of item shortages by analyzing the cause of the item shortage and reporting the shortage cause to related departments or the like, thereby reducing unnecessary expenditure and consumer dissatisfaction.

FIG. 5 is a flowchart illustrating an example of an operation of confirming a shortage cause due to obsolescence by a vendor by the electronic apparatus according to the example embodiments.

Some or all of the operations according to some example embodiments illustrated in FIG. 5 may be performed by the electronic apparatus according to the example embodiments. The electronic apparatus according to some example embodiments may confirm an item shortage in operation 500.

The electronic apparatus according to some example embodiments may confirm information indicating a vendor of an item (for example, information on a supplier of an item) in operation 501.

The electronic apparatus according to some example embodiments may store information on an item. The information on the item may include, for example, information indicating a vendor of the item. The vendor of the item may represent, for example, a supplier that supplies the item or may indicate a distributor that separately receives and distributes the item from a supplier. That is, when the item is received from a supplier, the electronic apparatus according to some example embodiments may store information on the supplier.

The electronic apparatus according to some example embodiments may confirm whether a vendor handles the item in operation 502. The electronic apparatus according to some example embodiments may confirm whether a vendor handles an item by using the information indicating the vendor of the item. The electronic apparatus may store a value indicating whether a vendor handles an item, a vendor identifier identifying the vendor, and mapped data in the storage 103 or database according to the example embodiments.

In operation 503, the electronic apparatus according to some example embodiments may determine a cause of an item shortage from other shortage causes when it is confirmed that the vendor of the item is not an obsolete (discontinued) vendor. When it is confirmed that the vendor of the item is an obsolete (discontinued) vendor, the electronic apparatus according to some example embodiments may determine the cause of the item shortage as the shortage cause due to obsolescence by the vendor in operation 504.

For example, the electronic apparatus according to some example embodiments may use order status information of an item by period included in the information on the item in order to confirm whether the item is handled by a vendor. In other words, when the electronic apparatus confirms that an order status of an item on the most recent order date of the item is activated, confirms whether a scheduled receiving date (or receiving date) for the order date is later than the occurrence date of item shortage, and confirms that the vendor of the item has discontinued (obsoleted) the item, the electronic apparatus may determine the cause of the item shortage as the shortage cause due to obsolescence by the vendor.

When the electronic apparatus according to some example embodiments determines the cause of the item shortage as the shortage cause due to obsolescence by the vendor, the electronic apparatus may search for other vendor(s) that handle the item. The electronic apparatus may generate a keyword for an item from the information on the item (for example, a category of an item, a name of an item, etc.). The keyword may be, for example, a character string generated by extracting or combining categories of an item and some names of an item. The electronic apparatus may generate a keyword for an item and then inquire of a vendor(s) associated with the keyword by using the generated keyword. The electronic apparatus may report the inquired vendor(s) to an administrator (or a terminal device of an administrator).

According to various example embodiments, it is possible for an electronic apparatus to quickly eliminate a shortage cause when the shortage cause is obsolescence by a vendor.

FIG. 6 is a diagram illustrating an example of an operation of confirming the shortage cause due to the state in which the order status of the item is inactive by the electronic apparatus according to the example embodiments.

Some or all of the operations according to some example embodiments illustrated in FIG. 6 may be performed by the electronic apparatus according to the example embodiments. Specifically, FIG. 6 may illustrate a precondition for the electronic apparatus to determine the cause of the item shortage as the shortage cause due to the order status of the item. That is, when at least one of the three conditions illustrated in FIG. 6 is satisfied, the electronic apparatus may determine the cause of the item shortage as the shortage cause due to the order status of the item according to certain requirements. In other words, in order for the electronic apparatus to determine the cause of the item shortage as the shortage cause due to the order status of the item, it is not necessary to satisfy all three conditions illustrated in FIG. 6. That is, the electronic apparatus may be configured to determine the cause of the item shortage as the shortage cause due to the order status of the item even when only one of the three conditions illustrated in FIG. 6 is satisfied, or the electronic apparatus may be configured to determine the cause of the item shortage as the shortage cause due to the order status of the item only when all three are satisfied.

The shortage cause due to the order status of the item may include, for example, the shortage due to 302 in FIG. 3 and the shortage due to the obsolescence of the item in FIG. 4, a shortage due to the deactivation of ordering of the item, or the like.

The electronic apparatus according to some example embodiments may store the information on the item. The information on the item may include information indicating the order status of the item by period. The order status of the item by period includes date information and the order status of the item on the date. The order status of the item is, for example, information indicating whether an item can be ordered from a supplier on that date, whether an order to a supplier is inactive for a separate reason, or the like. For example, when an order status of an item on a specific date is active, the electronic apparatus may place an order for an item with a supplier on the date.

(a) of FIG. 6 illustrates a first condition according to the example embodiments. As the first condition, when an order status of an item one day before the current date (i.e., the date when the item shortage occurs) is inactive, the electronic apparatus according to some example embodiments may confirm whether the cause of the item shortage is the shortage cause due to the order status of the item.

(b) of FIG. 6 illustrates a second condition according to the example embodiments. As the second condition, when the order status for the item is inactive X days before the current date (i.e., the date the item shortage occurred), there is a first order within the current period since the order, and the scheduled receiving date of the item for the first order is later than the current date, the electronic apparatus according to some example embodiments may confirm whether the cause of the item shortage is the shortage cause due to the order status of the item. Here, in the electronic apparatus, X may be set to be less than or equal to 14.

(c) of FIG. 6 illustrates a third condition according to the example embodiments. As the third condition, when an order status of an item one day before the current date (i.e., the date when the item shortage occurs) is inactive and there is no order for the item from the date X days before the current date to the present, the electronic apparatus according to some example embodiments may confirm whether the cause of the item shortage is the shortage cause due to the order status of the item. Here, in the electronic apparatus, X may be set to be less than or equal to 14.

According to various example embodiments, it is possible for an electronic apparatus to store an order status of an item by period and confirm whether the cause of the item shortage is the order status of the item by using the order status of the item stored by period, thereby clearly identifying whether a problem has occurred during an order or in an order cycle.

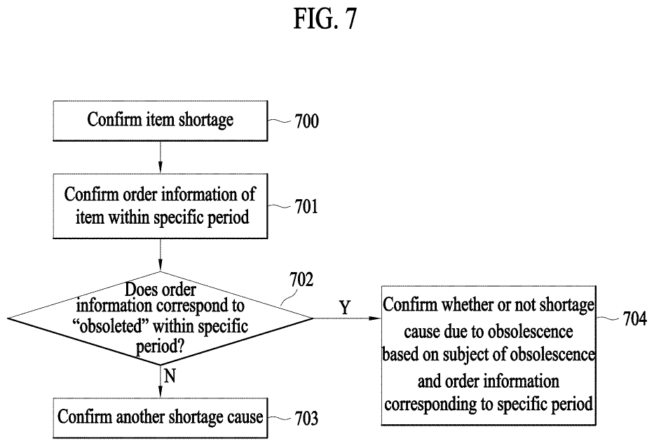

FIG. 7 is a flowchart illustrating an example of an operation of confirming the shortage cause due to the state in which the order status of the item is inactive by the electronic apparatus according to the example embodiments.

Some or all of the operations according to some example embodiments illustrated in FIG. 7 may be performed by the electronic apparatus according to the example embodiments. The electronic apparatus according to some example embodiments may confirm an item shortage in operation 700.

The electronic apparatus according to some example embodiments may confirm order information corresponding to a specific period of an item in operation 701. The order information corresponding to the specific period of the item may be included in, for example, the information on the item according to example embodiments. The order information corresponding to the specific period of the item may be the order information on the item by period described in FIG. 6.

The electronic apparatus according to some example embodiments may confirm whether the order information corresponding to the specific period corresponds to “obsolete” in operation 702. The electronic apparatus according to some example embodiments may confirm the order information by back-calculating the date by a specific number of days (for example, X days illustrated in FIG. 6) starting from the current date. The electronic apparatus according to some example embodiments may confirm that the order information for a specific number of days before the present is a discontinued status (an obsolete status).

When the obsolete status is not confirmed as a result of searching for the order information on the item from the present to a specific number of days, the electronic apparatus according to example embodiments may confirm the cause of the item shortage as another cause in operation 703. When the obsolete status is confirmed as a result of querying the order information on the item from the present to a specific number of days, the electronic apparatus according to example embodiments confirms whether the shortage cause due to the obsolescence is based on the order information for a specific period in operation 704. The electronic apparatus may perform operation 704, for example, by confirming whether at least one of the three conditions illustrated in FIG. 6 is satisfied.

The electronic apparatus according to some example embodiments may also confirm the subject of the obsolescence (for example, whether the item was discontinued (obsoleted) by the supplier or the fulfillment center, etc.) in the process of determining whether there is the shortage cause due to the obsolescence.

When the cause of the item shortage is determined as the shortage cause due to the order status of the item, the electronic apparatus according to example embodiments may determine whether to change the order status of the item to the active state, and determine the appropriate order cycle of the item. For example, in order to determine the order status of the item as the active state, the electronic apparatus according to example embodiments may confirm a subject of obsolescence of an item, whether an item is a seasonal product, and whether an item is discontinued (obsoleted) due to a social issue. For example, when a subject who stops handling an item is a supplier, the electronic apparatus may confirm whether a negotiation is requested by the supplier, and then confirm an order status of the item when there is no request for negotiation. For example, the electronic apparatus may confirm a season period of an item from the information on the item when the item is confirmed as a seasonal product based on the information on the item and activate an order status of the item when the current date is the season period of the item. For example, when it is confirmed that an item has been discontinued (obsoleted) due to a social problem based on the information on the item, the electronic apparatus may confirm whether the social problem continues and then activate the order status of the item.

A seasonal item (seasonal product) is, for example, an item of which many are sold in a specific season or a product that can only be sold in a specific season. For example, when a specific item is an item of which many are sold in a specific season (for example, a Chuseok gift set, etc.), but which is also often sold in periods other than the season, the item shortage may occur temporarily. As another example, when a specific item is an item that is sold only in a specific season (for example, an event product, a limited edition product, etc.), the item shortage may occur in periods other than the season.

In addition, the electronic apparatus according to example embodiments may set an appropriate order cycle of an item. For example, when at least one of the second condition and the third condition illustrated in FIG. 6 is satisfied, the electronic apparatus may set an appropriate order cycle of an item. An appropriate order cycle of an item may be determined based on a value of days X described in FIG. 6. In the case of (b) of FIG. 6, an appropriate order cycle for an item according to example embodiments is appropriate for a period from an order that occurs after X days before the current date to a scheduled receiving date of the order (or a shorter period). In the case of (c) of FIG. 6, an appropriate order cycle of an item according to example embodiments may be determined as a period in which a specific ratio (for example, 50% or 70%) of X days decreases.

According to various example embodiments, it is possible for an electronic apparatus to store an order status of an item by period and confirm whether the cause of the item shortage is the order status of the item by using the order status of the item stored by period, thereby clearly identifying whether a problem has occurred during an order or in an order cycle.

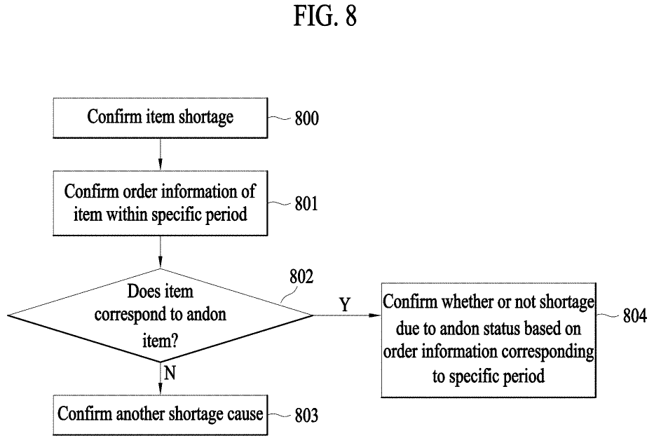

FIG. 8 is a flowchart illustrating an example of an operation of confirming a shortage cause due to an andon status of an item by the electronic apparatus according to example embodiments.

Some or all of the operations according to some example embodiments illustrated in FIG. 8 may be performed by the electronic apparatus according to example embodiments. The electronic apparatus according to some example embodiments may confirm an item shortage in operation 800.

The electronic apparatus according to some example embodiments may confirm order information corresponding to a specific period of an item in operation 801. The order information corresponding to the specific period of the item may be included in, for example, the information on the item according to the example embodiments. The order information corresponding to the specific period of the item may be the order information on the item by period described in FIG. 6.

The electronic apparatus according to some example embodiments may confirm whether the order information for a specific time is in an inactive state, as illustrated in FIG. 6. The inactive state may include an andon state of an item. The andon may mean, for example, that when a problem occurs in a specific item, the item is not sold until the problem is resolved. The problem with the item may include, for example, a case in which a cause for a customer complain about an item is received and thus needs to be resolved, and may include a case in which safety issues or statutory issues of an item limit sales of the item and thus need to be resolved.

In other words, the andon status of the item is a case in which a problem occurs with the item (for example, a customer complaint or an accident occurs), and the electronic apparatus does not order an item with a supplier because the item cannot be sold until the problem is resolved. Accordingly, when a problem occurs with an item, the electronic apparatus may change the order status of the item from the activated state to the andon status which is one of the inactive states. Accordingly, when the item shortage occurs because the order is not in progress, the shortage cause may be confirmed as andon.

That is, when an item shortage occurs, the electronic apparatus according to example embodiments may confirm whether the order status of the item at a specific time is the andon status in operation 802. The specific time may be, for example, a time a specific number of days before the present time, as illustrated in FIG. 6.

When it is confirmed that an order status of an item at a specific time is not the andon status, the electronic apparatus according to some example embodiments may confirm other causes of the shortage in operation 803. When it is confirmed that an order status of an item at a specific time is an andon status, the electronic apparatus according to example embodiments may determine the cause of the item shortage as the shortage due to the andon status. The shortage due to the andon status may refer to, for example, the shortage due to the deactivation of the order of the item in FIG. 4.

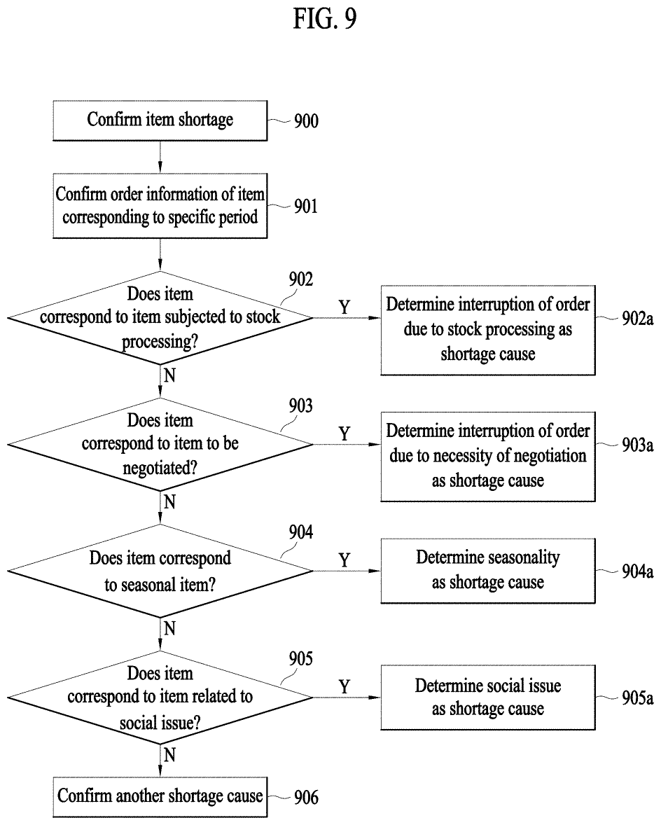

FIG. 9 is a flowchart illustrating an example of an operation of confirming a shortage cause due to an order status of an item by the electronic apparatus according to example embodiments.

Some or all of the operations according to some example embodiments illustrated in FIG. 9 may be performed by the electronic apparatus according to example embodiments. The electronic apparatus according to some example embodiments may confirm an item shortage in operation 900.

The electronic apparatus according to some example embodiments may confirm order information corresponding to a specific period of an item in operation 901. The order information corresponding to the specific period of the item may be included in, for example, the information on the item according to the example embodiments. The order information corresponding to the specific period of the item may be the order information on the item by period described in FIGS. 6 and 8.

The electronic apparatus according to some example embodiments may confirm whether the item of which the shortage occurs corresponds to an item subjected to stock adjustment in a specific period, based on order information corresponding to a specific period in operation 902. When it is confirmed that stock of the item has been adjusted in a specific period, the electronic apparatus according to example embodiments may determine the cause of the item shortage as the shortage cause due to the order interruption due to the stock adjustment in operation 902a.

The electronic apparatus according to some example embodiments may confirm whether the item of which a shortage occurs corresponds to an item requiring negotiation with a supplier based on order information corresponding to a specific period in operation 903. When it is confirmed that the item is an item requiring negotiation with a supplier, the electronic apparatus according to example embodiments may determine the cause of the item shortage as a shortage cause due to the order interruption due to necessity of negotiation in operation 903a.

The electronic apparatus according to some example embodiments may confirm whether the item of which a shortage occurs corresponds to a seasonal item based on order information corresponding to a specific period in operation 904. When it is confirmed that the item is a seasonal item, the electronic apparatus according to example embodiments may determine the cause of the item shortage as the shortage cause due to the seasonal item in operation 904a.

The electronic apparatus according to some example embodiments may confirm whether the item of which a shortage occurs corresponds to a product related to a social issue based on order information corresponding to a specific period in operation 905. When it is confirmed that the item is an item related to a social issue, the electronic apparatus according to example embodiments may determine the cause of the item shortage as the shortage cause due to the social issue in operation 905a.

When none of the above conditions of operations 902 to 905 are satisfied, the electronic apparatus according to example embodiments may confirm the cause of the item shortage as another shortage cause in operation 906.

FIG. 10 is a flowchart illustrating an example of an operation of confirming a shortage cause due to a defect in a fulfillment center or the like by the electronic apparatus according to example embodiments.

Some or all of the operations according to some example embodiments illustrated in FIG. 10 may be performed by the electronic apparatus according to example embodiments. The electronic apparatus according to some example embodiments may confirm an item shortage in operation 1000.

The electronic apparatus according to some example embodiments may confirm whether stock of an item is adjusted within a specific period in operation 1001.

The stock adjustment means that, when there is a change in a stock of an item within a fulfillment center, the stock within the fulfillment center decreases or increases arbitrarily or with the operation of the system. For example, when an item is lost within a fulfillment center, the stock adjustment may include adjusting the item according to the amount lost (or the remaining quantity). As another example, when the period in which some of the items stored in the fulfillment center can be sold has passed (i.e., the code life has expired), the stock of the items may be adjusted according to the number of items whose code life has expired. The electronic apparatus according to some example embodiments may store whether a stock of an item is adjusted by date, a quantity of an item of which stock has been adjusted, and a cause of the stock adjustment.

For example, the stock adjustment may be performed by adjusting information on usable stock and information on available stock of each item in a fulfillment center. The usable stock may represent the number of items in a fulfillment center(s) shown to a purchaser who wants to purchase the item. The available stock may represent the number of items that can be shipped within the actual fulfillment center. When there is a change in the stock amount of an item within the fulfillment center, the electronic apparatus according to example embodiments may adjust available stock within the fulfillment center. Meanwhile, when an item is sold excessively and a quantity of an item available for delivery in a fulfillment center is less than the sales amount of the item, the electronic apparatus according to example embodiments may temporarily adjust the usable stock and show the adjusted usable stock to the purchasers as if the item were sold out. The electronic apparatus according to some example embodiments may confirm item shortage according to whether the available stock is 0.

When it is confirmed that stock of an item has been adjusted within a specific period, the electronic apparatus according to example embodiments may determine the cause of the item shortage as the shortage cause due to the stock adjustment in operation 1002.

When stock of an item is not adjusted within a specific period, the electronic apparatus according to example embodiments may confirm the stock-related information of the item from the item-related information in operation 1003. The receiving-related information of the item may include times when the item is unloaded, received, and stowed in the fulfillment center.

The electronic apparatus according to some example embodiments may confirm whether a difference between the stow time and the unloading time is a specific time or more based on the stock-related information of the item in operation 1004. When it is determined that the difference between the stow time and the unloading time of the item is more than a specific time, the electronic apparatus according to example embodiments may determine the cause of the item shortage as the shortage cause due to the stowing delay in operation 1005. When the difference between the stow time and the unloading time of the item is less than a specific time, the electronic apparatus according to example embodiments may confirm other causes of the shortage in operation 1006.

Meanwhile, the electronic apparatus according to example embodiments may unload several items into a fulfillment center and then receive and stow items on the basis of stow scheduling information. The stow scheduling may be only scheduling a process of receiving and stowing several items in a fulfillment center. The electronic apparatus according to some example embodiments may include information indicating display scheduling (display scheduling information) in a storage or a database according to the example embodiments.

The display scheduling information may include, for example, an item identifier for identifying an item, a receiving weight for determining an order of receiving items, and a stow weight for determining an order of stowing items.

The electronic apparatus according to some example embodiments may set a receiving time early for items having a high receiving weight, and set a receiving time late for items having a low receiving weight. As another example, the electronic apparatus according to example embodiments may arrange items having a high receiving weight in a priority order in the receiving order of the item. For example, the electronic apparatus according to example embodiments may determine the order of receiving items in the order of items having a high receiving weight.

Similarly, the electronic apparatus according to example embodiments may set a stow time early for items with a high stow weight, and set a stow time late for items with a low stow weight. As another example, the electronic apparatus according to example embodiments may arrange items having a high stow weight in a priority order in the stow order of the item. For example, the electronic apparatus according to example embodiments may determine the order of stowing items in the order of items having a high stow weight.

When the cause of the item shortage is the shortage cause due to the stowing delay as determined in operation 1005, the electronic apparatus according to example embodiments may increase the stow weight of the item in the stow scheduling information.

The electronic apparatus according to some example embodiments may reduce the occurrence of stowing delay of the item due to this operation, and take quick actions so that the consumer is disadvantaged due to the stowing delay, that is, no shortage occurs due to the stowing delay.

Furthermore, according to example embodiments, the case in which the shortage occurs because an item is neglected without being stowed (i.e., the shortage cause due to the neglect in the fulfillment center) may also be included as the shortage cause due to the defect in the fulfillment center. In other words, the shortage due to the neglect in the fulfillment center may mean that the item shortage occurs because the item is received in the fulfillment center but is neglected for a specific time or more (for example, 72 hours, etc.) without being stowed or is processed as being lost or scrapped.

When the received amount of items is plural items (e.g., two or more items are received), and the items have been received for a specific time or more (for example, 72 hours) without being stowed, the electronic apparatus according to example embodiments may determine the shortage cause as the shortage cause due to the neglect in the fulfillment center. The electronic apparatus may confirm whether a specific time (for example, 72 hours) has elapsed without the items being stowed by calculating the difference between the information indicating the receiving time of the item and the stow time of the item.

FIG. 11 is a flowchart illustrating an example of an operation of confirming a shortage cause due to a small order amount by an electronic apparatus according to example embodiments.

Some or all of the operations according to some example embodiments illustrated in FIG. 11 may be performed by the electronic apparatus according to example embodiments. The electronic apparatus according to some example embodiments may confirm an item shortage in operation 1100.

The electronic apparatus according to some example embodiments may confirm information on an order of an item from the information on the item in operation 1101. The information on the order of the item may be included in the information on the item in FIG. 2, and may include information on the order of the item in FIGS. 7 to 9. The information on the order of the item may include a limit to which the fulfillment center in which the item is stored can accommodate the item (that is, the capacity of the fulfillment center).

The information on the order of the item according to some example embodiments may also include information on whether there is a history in which the order quantity of the item has changed due to the capacity of the fulfillment center. For example, when the limit of the first fulfillment center that can accommodate the item is 10, and the order quantity of the item is 12, some of the order quantity of the item may be stored in the first fulfillment center. Accordingly, the order quantity of the item is inevitably reduced due to the capacity of the fulfillment center, and the electronic apparatus may further include the reduced order quantity and the time when it is determined to decrease the order quantity in the information on the order of the item. For example, the electronic apparatus according to example embodiments may perform an operation of a system for reducing an order quantity of an item, that is, an operation of an order quantity control system, based on the capacity of the fulfillment center. The order quantity reduction system may confirm the order quantity (merged MOQ) of the total item by summing the order quantity of the item in the unit of the chamber in the fulfillment center for each receiving date of the item. The total order quantity of the item according to some example embodiments may be included in the information on the item. The electronic apparatus according to some example embodiments may forecast the received quantity of items based on the confirmed total order quantity of the item, and may compare the forecasted received quantity with the capacity of the fulfillment center on the stocking date.

Here, the received quantity of items may be calculated by multiplying the order quantity of the item requested from the supplier by the fill rate of the item. For example, even when the fulfillment center orders 100 specific items, when a supplier delivers only 80, the received quantity of items may be 80. In this case, the fill rate (supplier fill rate) may be 80%. That is, the electronic apparatus according to example embodiments may execute an order quantity control system at the time of ordering an item. In this case, the electronic apparatus may calculate the forecasted fill rate (historical supplier fill rate) based on the past delivery performance of each supplier and forecast the forecasted received amount using the calculated forecasted fill rate. The electronic apparatus may compare the capacity of the fulfillment center with the predicted received amount of the item for the supplier. When the capacity of the fulfillment center is smaller than the received quantity of items, the electronic apparatus may lower the order quantity of the item by the quantity corresponding to the excessive received amount of the item.

Therefore, the electronic apparatus according to example embodiments may confirm whether the item has a history of the order quantity decreasing due to the capacity of the fulfillment center within a specific time from the present while confirming the information on the order of the item in operation 1102. When there is no history of a decrease in the order quantity due to the capacity of the fulfillment center, the electronic apparatus may identify the cause of the item shortage as another cause in operation 1104.

When there is a history of a decrease in the order quantity due to the capacity of the fulfillment center, the electronic apparatus may further confirm whether the fill rate of the item based on the item order is greater than or equal to a certain ratio in operation 1103. The fill rate of the item is represented by a ratio of the quantity of items received from the actual supplier compared to the quantity of items that are decided to be ordered.

When the fill rate of the item based on the item order is less than a certain ratio (for example, 80%, etc.), the electronic apparatus according to example embodiments may confirm the cause of the item shortage as another cause in operation 1104, because the cause of the item shortage may not be that an order quantity of an item is small, but that an item has not been sufficiently supplied from a supplier.

When the fill rate of the item based on the item order is greater than or equal to a certain ratio (for example, 80%, etc.), the electronic apparatus according to example embodiments may determine the cause of the item shortage as the shortage cause due to the small order quantity of the item in operation 1105.

When the electronic apparatus according to some example embodiments determines that the cause of the item shortage is the shortage cause due to the small order quantity of the item in operation 1105, it is necessary to increase the capacity of the order quantity of the item and the fulfillment center of the item. Therefore, the electronic apparatus according to some example embodiments may confirm the remaining acceptable quantity of the fulfillment center for storing the item. The electronic apparatus according to some example embodiments may determine an appropriate order quantity or an appropriate order cycle for an item based on the confirmed remaining acceptable quantity and the sales amount for each period of the item. The electronic apparatus may order an item with suppliers based on the determined appropriate order quantity.

The electronic apparatus according to some example embodiments may reduce the capacity of all items (or the items stored in the same sector as the item in which the defect occurs) stored in the fulfillment center and an item(s) of which a shortage does not occur, and items that are scrapped due to the expiration of the code life of the item. The electronic apparatus may determine the remaining acceptable quantity based on the reduced capacity and add the remaining acceptable quantity to the capacity of the existing fulfillment center of the item of which the shortage has occurred.

The electronic apparatus according to some example embodiments may determine the appropriate order quantity for the item. The appropriate order quantity may be determined by increasing the number of existing orders for the item. The appropriate order quantity may be found by increasing the existing order quantity based on, for example, sales amount information of the item.

With this configuration, the electronic apparatus according to example embodiments may prevent an item shortage due to the limit of the capacity of the fulfillment center and optimize the use of the fulfillment center.

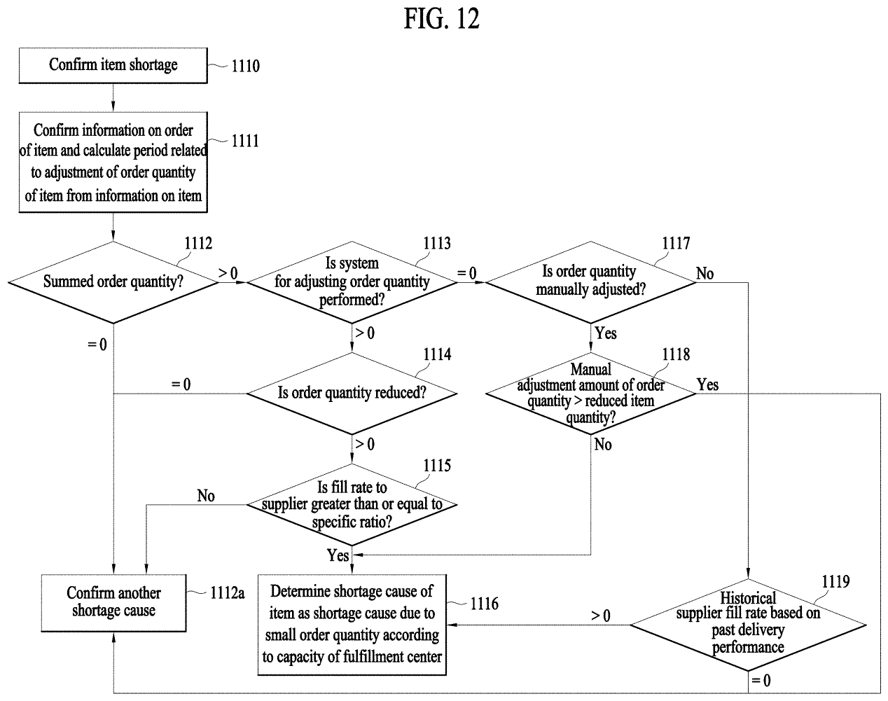

FIG. 12 is a flowchart illustrating an example of an operation of confirming a shortage cause due to a small order quantity according to a capacity of the fulfillment center according to the example embodiments.

Some or all of the operations according to some example embodiments illustrated in FIG. 12 may be performed by the electronic apparatus according to example embodiments. The electronic apparatus according to some example embodiments may confirm an item shortage in operation 1110. The electronic apparatus according to some example embodiments may confirm information on an item order from the information on the item and may calculate a period related to the adjustment of the order quantity of the item in operation 1111. The period related to the order quantity adjustment may indicate a period including details in which the electronic apparatus adjusts the order quantity of the item due to the limit of the capacity of the fulfillment center. The electronic apparatus according to some example embodiments may confirm information on an order of an item for the calculated period.

The electronic apparatus according to some example embodiments may calculate the total sum of the order quantity of the item from the information on the order of the item in operation 1112. When the total number of summed order quantities is 0, the item shortage is not related to the shortage cause indicated by the decrease in the order quantity according to the capacity of the fulfillment center, and therefore other causes of the shortage may be confirmed in operation 1112a. When the total number of summed order quantities is greater than 0, the electronic apparatus according to example embodiments may confirm the number of times the order quantity control is performed by the order quantity control system in operation 1113. When the electronic apparatus performs order quantity control more than once by the order quantity control system, the order quantity that has been adjusted and decreased may be confirmed in operation 1114. When the total number of reduced order quantities is 0, the item shortage is not related to the shortage cause indicated by the decrease in the order quantity according to the capacity of the fulfillment center, and therefore other causes of the shortage may be confirmed in operation 1112a. When the reduced order quantity is greater than 0, the electronic apparatus according to example embodiments may confirm the fill rate of the item from a supplier in operation 1115, and when the fill rate of the item is 90% or more, the shortage cause due to the small order quantity according to the capacity of the fulfillment center may be determined as the cause of the item shortage in operation 1116. When the fill rate of an item is smaller than a specific percentage (90%), the electronic apparatus may confirm other shortage causes.

When the number of times the order quantity adjustment is performed by the order quantity control system is 0, in operation 1117, the electronic apparatus according to example embodiments may confirm whether there are details of manually adjusting the order quantity within the period calculated in operation 1111. When there are details of manually decreasing the order quantity of the item, the electronic apparatus may confirm whether the decrease in the order quantity of the item is more than the decrease in the stock of the item in operation 1118, and then confirm other shortage causes when the reduction amount of the order quantity of the item is greater than or equal to the stock reduction amount of the item in operation 1112a, and may determine the shortage cause due to the small order quantity according to the capacity of the fulfillment center as the cause of the item shortage in operation 1116 when the reduction amount in the order quantity of the item is less than the stock reduction amount of the item. When there are no details of manually reducing the order quantity of the item, the order quantity is adjusted by the order quantity control system at the time of ordering, and therefore the forecasted fill rate (historical supplier fill rate) may be calculated based on the past delivery performance of each supplier in operation 1119. When the calculated forecasted fill rate is greater than 0, the electronic apparatus may determine the shortage cause due to the small order quantity according to the capacity of the fulfillment center as the cause of the item shortage in operation 1116, and in other cases, may confirm another shortage cause in operation 1112a.

The electronic apparatus according to some example embodiments may determine the appropriate order quantity for the item. The appropriate order quantity may be determined by increasing the number of existing orders for the item. The appropriate order quantity may be found by increasing the existing order quantity based on, for example, sales amount information of the item.

With this configuration, the electronic apparatus according to example embodiments may prevent item shortages due to the limit of the capacity of the fulfillment center and optimize the use of the fulfillment center.

FIG. 13 is a flowchart illustrating an example of an operation of confirming a shortage cause due to a sales amount of an item by the electronic apparatus according to example embodiments.

Some or all of the operations according to some example embodiments illustrated in FIG. 13 may be performed by the electronic apparatus according to example embodiments. The electronic apparatus according to some example embodiments may confirm an item shortage in operation 1200.

The electronic apparatus according to some example embodiments may confirm information on a sales amount of an item from the information on the item in operation 1201. The information on the sales amount of the item may be included in the information on the item in FIG. 2 and may include information on the sales amount of the item in FIGS. 7 to 9 and 11. The information on the sales amount of the item may include information indicating a quantity of items sold to purchasers by period.

The electronic apparatus according to some example embodiments may confirm whether there is a spike in sales of the item of which the shortage occurs in operation 1202. A spike in sales may be a case in which a sales amount of an item increases rapidly in a short period of time. A spike in sales may be confirmed, for example, by comparing a sales amount (or sales amount) of an item sold in a first period and a sales amount (or sales amount) of the item sold in a second period following the first period. That is, the electronic apparatus may confirm the spike in sales of the item by confirming the first period and the second period. For example, when the average sales amount of the item in the second period is greater than or equal to twice the average sales amount of the item in the first period, the electronic apparatus may confirm that the spike in sales has occurred in the second period. The first period may be set as, for example, a period from 14 days before the occurrence of the shortage to 7 days before the time when the shortage occurs. The second period may be set as, for example, a period from 7 days before the occurrence of the shortage to the point of occurrence of the shortage.

For example, the electronic apparatus according to example embodiments may confirm the spike in sales of the item in operation 1202 in the following process. It is assumed that the first period is from 14 days before the occurrence of the shortage to 7 days before the time of the occurrence of the shortage, and the second period is from 7 days before the occurrence of the shortage to the time when the shortage occurs.

First, the electronic apparatus according to example embodiments may confirm whether a first condition variable C1A is true/false in order to perform operation 1202. An average sales amount A/a of an item for the first period and an average sales amount B/b of the item for the second period are calculated, and when the average sales amount B/b for the second period is more than twice the average sales amount A/a, a first condition variable C1A is determined to be true. Here, A may be a total sales amount for the first period, a may be the number of daily units for the first period, B may be the total sales amount for the second period, and b may be the number of daily units for the second period. That is, the first condition variable C1A may be calculated as follows.

C1A=(2*A/a<B/b)?True:False

Next, the electronic apparatus according to example embodiments may confirm whether the second condition variable C1B is true/false. The second condition variable C1B is determined to be true when the sales amount on the day the item is sold most within the second period is more than three times the average sales amount A/a of the item for the first period. That is, the second condition variable C1B may be calculated as follows.

C1B=3*A/a<max(daily sales amount for first period)?True:False

Next, when both the first condition variable C1A and the second condition variable C1B are true (i.e., when C1=C1A OR C1B is calculated and C1 is true), the electronic apparatus according to example embodiments may confirm that the spike in sales occurs in the second period. When the spike in sales occurs in the second period, the electronic apparatus according to example embodiments may determine the cause of the item shortage as the shortage cause due to the sales amount of the item in operation 1104. That is, in order for the electronic apparatus to determine the cause of the item shortage as the shortage cause due to the sales amount of the item, the following conditions may be confirmed. In other words, it is indicated that the spike in sales is the shortage cause due to the sales amount of the item.

Spike in Sales=C1A OR C1B

The electronic apparatus according to some example embodiments may further confirm additional conditions to perform operation 1202. For example, the electronic apparatus according to example embodiments may confirm whether the item was ordered before the spike in sales occurred (for example, the date the item was sold most within the second period, etc.) and the scheduled receiving date of the item for the order is after the spike in sales occurred (e.g., condition C2). When the condition C2 is not satisfied, the electronic apparatus may determine the cause of the item shortage as the shortage cause due to the sales amount of the item. In other words, when there is no new order after the spike in sales occurs based on the occurrence date of the item shortage, the electronic apparatus according to example embodiments may determine the cause of the item shortage as the shortage cause due to the sales amount of the item. Meanwhile, even when the condition C2 according to some example embodiments is satisfied, it is possible to confirm whether the item is in an undelivered/unsold state or the item is in a delayed delivery from the time when the spike in sales occurs (e.g., condition C3). When both conditions C2 and C3 are satisfied, the electronic apparatus according to example embodiments may determine the cause of the item shortage as the shortage cause due to the sales amount of the item. In other words, it is indicated that the spike in sales is the shortage cause due to the sales amount of the item.

Spike in Sales=(C1 AND ˜C2) OR (C1 AND C2 AND C3)

The electronic apparatus according to some example embodiments may readjust the order cycle of the item when determining the cause of the item shortage as the shortage cause due to the sales amount of the item. That is, the electronic apparatus may secure an item stock by reducing the order cycle of the item only to a specific number of times when the spike in sales occurs. The order cycle of the item may be determined, for example, in proportion to the sales amount of the second period compared to the sales amount of the first period. That is, when the sales amount for the first period doubles compared to the second period, the order cycle needs to be 2 times as fast, and therefore the order cycle may be reduced to 0.5 times.

The electronic apparatus according to some example embodiments may quickly identify the cause of the item shortage by adapting to a sudden change in the sales amount of the item and quickly cope with the sudden change in the sales amount when the item shortage occurs.

In other words, the information on the item according to some example embodiments may include a first sales amount indicating the sales amount of the item for the first period, and a second sales amount indicating the sales amount of the item for the second period after the first period, and the operation of confirming the cause of the item shortage may further include confirming whether the cause of the item shortage is the fifth shortage cause by calculating a ratio of the second sales amount to the first sales amount.

FIG. 14 is a flowchart illustrating an example of an operation of confirming a shortage cause due to a supplier by the electronic apparatus according to example embodiments.

Some or all of the operations according to some example embodiments illustrated in FIG. 14 may be performed by the electronic apparatus according to example embodiments. The electronic apparatus according to some example embodiments may confirm an item shortage in operation 1300.

The electronic apparatus according to some example embodiments may confirm information on the receiving of an item from the information on the item in operation 1301a. The information on the receiving of the item may be included in the information on the item in FIG. 2. The information on the receiving of the item may include, for example, the quantity of the item received in the fulfillment center, the time when the item is received, or the like.

The electronic apparatus according to some example embodiments may confirm information indicating a return of an item within a specific period from the information on the item in operation 1301b. The information indicating the return of the item within the specific period may be included in the information on the item in FIG. 2. The information indicating the return of the item within the specific period may include the number of returns of the item within the specific period, and the cause of returning the item. The specific period may be, for example, one week, may be variously set to 14 days, 30 days, etc., and may be determined differently according to the category of the item, the sales amount of the item, and the like.

For example, when the number of returns of an item is more than 20% of the number of sales of the item, since there is a strong possibility that there is a problem in the quality of the item, and because the returned item cannot be resold, waste is generated and the remaining stock is insufficient, and therefore the item shortage may occur.

Accordingly, the electronic apparatus according to example embodiments may confirm whether the number of returns of the item within the specific period is greater than or equal to a specific number of times (or a specific ratio to the sales amount of the item) in operation 1302a. In addition, in operation 1302b, the electronic apparatus according to example embodiments may also confirm whether the number of returns within the specific period is greater than or equal to a specific ratio of the number of items received. When the number of returns of the item within the specific period is greater than or equal to a specific number (or a specific percentage), and the number of returns within the specific period is greater than or equal to a specific percentage of the number of items received, the electronic apparatus according to example embodiments may determine the cause of the item shortage as the shortage cause based on the quality problem of the item delivered by the supplier in operation 1302c.

When any one of the conditions of operations 1302a and 1302b is not satisfied, the electronic apparatus according to example embodiments may confirm whether the cause of the item shortage is the shortage cause due to the lack of item delivery by the supplier. That is, the electronic apparatus according to example embodiments may confirm whether the fill rate of the item is smaller than or equal to a specific value in operation 1303.

When the fill rate of the item is smaller than or equal to a specific value, the electronic apparatus according to example embodiments may determine the cause of the item shortage as the cause of the supply shortage of the item in operation 1303a. When the fill rate of the item is greater than a specific value, the electronic apparatus according to example embodiments may confirm the cause of the item shortage as another cause.

The electronic apparatus according to some example embodiments may report shortage information including fill rates to a department related to the supplier when determining the lack of the item delivery by the supplier as the shortage cause.

With this operation, the electronic apparatus according to example embodiments may mechanically and effectively confirm whether the cause of the item shortage is a shortage due to the cause of the supplier and prevent an additional shortage of item.

FIG. 15 illustrates examples of an operation of confirming a shortage cause due to a lack of item delivery by a supplier by the electronic apparatus according to example embodiments.

Some or all of the operations according to some example embodiments illustrated in FIG. 15 may be performed by the electronic apparatus according to example embodiments. Specifically, FIG. 15 illustrates example embodiments in which the electronic apparatus determines the cause of the item shortage as the shortage cause due to the lack of item delivery by the supplier. That is, when at least one of the three examples illustrated in FIG. 15 is satisfied, the electronic apparatus may determine the cause of the item shortage as the shortage cause due to the lack of the item delivery according to certain requirements. In other words, in order for the electronic apparatus to determine the cause of the item shortage as the shortage cause due to the lack of the item delivery, it is not necessary to satisfy all three conditions illustrated in FIG. 15. That is, even when the electronic apparatus satisfies only one of the three example embodiments illustrated in FIG. 15, the cause of the item shortage may be determined as the shortage cause due to the lack of the item delivery by the supplier according to certain requirements.

The shortage cause due to the lack of the item delivery by the supplier may include, for example, the shortage cause 306 of FIG. 3, the shortage due to the supplier in FIG. 4, or the like.

The electronic apparatus according to some example embodiments may store the information on the item. The information on the item may include the fill rate (fill rate) of the item received from the supplier by period (or by order unit). That is, the electronic apparatus according to some example embodiments may store the fill rate of items by period, that is, the ratio of the quantity of items actually received by the fulfillment center for the order compared to the quantity of items decided to be supplied in a specific order.

(a) of FIG. 15 shows an example of determining a shortage cause due to a shortage of item delivery by a supplier according to example embodiments.

For example, when the item shortage occurs, the electronic apparatus according to example embodiments may confirm whether an item is ordered and whether an item is received by an order deadline within the period back-calculated for 15 days from the occurrence date of the item shortage. Referring to (a) of FIG. 15, the electronic apparatus may confirm that there are one order (order 1) and one receipt (receipt 1) within a period back-calculated for 15 days from the occurrence date of the item shortage. In this case, the electronic apparatus according to example embodiments confirms the order quantity of the confirmed item of order 1, confirms the received amount of the confirmed item of receipt 1, and then confirms the fill rate for order 1. When the fill rate is less than a specific ratio (90%, etc.), the electronic apparatus may determine the cause of the item shortage as the shortage cause due to the lack of the item delivery by the supplier.

(b) of FIG. 15 shows another example of determining a shortage cause due to a lack of item delivery by a supplier according to example embodiments.

Referring to (b) of FIG. 15, the electronic apparatus may confirm that there are three orders (order 1 to order 3) and three receipts (receipt 1 to receipt 3) within a period back-calculated for 15 days from the occurrence date of the item shortage. In this case, the electronic apparatus according to example embodiments confirms the order quantity for each of the two orders closest to the occurrence date of shortage among confirmed orders 1 to 3 (i.e., order 2 and order 3). Similarly, the electronic apparatus confirms the received amount for each of the two receipts closest to the occurrence date of shortage of the confirmed receipt 1 to receipt 3 (i.e., receipt 2 and receipt 3). After that, the electronic apparatus confirms the fill rate for each of order 2 and order 3.

When a supplier for order 2 and a supplier for order 3 are the same supplier, and at least one of the fill rates for order 2 and order 3 is a specific ratio (90%, etc.) or less, the electronic apparatus may determine the shortage cause as the shortage cause due to the lack of the item delivery by the supplier.

When a supplier for order 2 and a supplier for order 3 are different suppliers, the electronic apparatus confirms fill rates for each of order 2 and order 3, and when an order with a fill rate below a certain percentage (90%, etc.) is confirmed, the electronic apparatus may determine the cause of the item shortage as the shortage cause due to the lack of item delivery for the order by the supplier.

(c) of FIG. 15 shows another example of determining a shortage cause due to a shortage of item delivery by a supplier according to example embodiments.

Referring to (c) of FIG. 15, the electronic apparatus may confirm that there are one order (order 1) and two receipts at different fulfillment centers (receipt 1 and receipt 2) within a period back-calculated for 15 days from the occurrence date of the item shortage. In this case, the electronic apparatus according to example embodiments may check the order quantity of the confirmed order 1, confirm the received amounts of the confirmed receipt 1 and receipt 2, and sum the received amounts to confirm the summed received amount. When three or more receipts at three or more fulfillment centers occur, it is possible to confirm the summed received amount by summing all the quantities of items received in all the fulfillment centers. After that, the electronic apparatus may confirm the fill rate for order 1 based on the order quantity of order 1 and the summed received amount. When the fill rate is less than a specific ratio (90%, etc.), the electronic apparatus may determine the cause of the item shortage as the shortage cause due to the lack of the item delivery by the supplier.

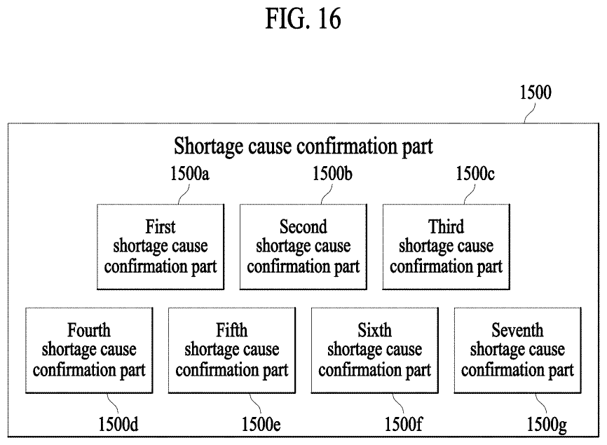

FIG. 16 is a diagram illustrating an example of a configuration diagram of the electronic apparatus according to example embodiments.

The electronic apparatus according to some example embodiments illustrated in FIG. 16 may be the electronic apparatus according to some example embodiments described with reference to FIGS. 1 to 15. The electronic apparatus according to some example embodiments may include at least one of a first shortage cause confirmation part 1500a, a second shortage cause confirmation part 1500b, a third shortage cause confirmation part 1500c, a fourth shortage cause confirmation part 1500d, a fifth shortage cause confirmation part 1500e, a sixth shortage cause confirmation part 1500f, and a seventh shortage cause confirmation part 1500g. The first shortage cause confirmation part to the seventh shortage cause confirmation part 1500a to 1500g may determine one or more of the first shortage cause to the seventh shortage cause according to some example embodiments based on each logic of the cause of the item shortages in response to confirming the item shortage.

The first shortage cause according to some example embodiments may include the shortage cause 301 due to obsolescence by the vendor in FIG. 3, and may include the shortage cause due to obsolescence by the vendor in FIG. 4. The first shortage cause confirmation part 1500a according to some example embodiments may perform, for example, the operation illustrated in FIG. 5 to confirm whether the cause of the item shortage is the first shortage cause according to the example embodiments.

The second shortage cause according to some example embodiments may include the shortage cause due to the order status of the item in FIG. 3, and the shortage cause due to the discontinuation (obsolete) of the item in FIG. 4, and the shortage cause due to the deactivation of the item, and the shortage cause due to the nature of the item. The second shortage cause confirmation part 1300b according to some example embodiments may perform some or all of the operations illustrated in FIGS. 6 to 9, for example, to confirm whether the cause of the item shortage is the second shortage cause according to the example embodiments.

The third shortage cause according to some example embodiments may include the shortage cause due to the defect in the fulfillment center in FIG. 3, the shortage cause due to the defect in the fulfillment center in FIG. 4, and the shortage cause due to the defect in the cross dock. The third shortage cause confirmation part 1500c according to some example embodiments may perform, for example, the operation illustrated in FIG. 10 to confirm whether the cause of the item shortage is the third shortage cause according to the example embodiments. In the example embodiment, the item related to the cross dock may include items that need to be moved between a plurality of fulfillment centers by an operating subject related to an electronic apparatus. For example, a supplier may deliver an item to the first fulfillment center, and the movement from the first fulfillment center to the second fulfillment center where the item actually needs to be received may be performed by an operating subject related to the electronic apparatus. Therefore, when the shortage occurs because a supplier properly performs the delivery to the first fulfillment center, but the delivery to the second fulfillment center is not done on time by the cross dock procedure, the cause of the item shortage may be determined as the shortage due to the cross dock.

For example, there may be a case where an item is unloaded from a supplier into the first fulfillment center, and then loaded again into the first fulfillment center, moves to the second fulfillment center, and is then unloaded and received in the second fulfillment center. Therefore, when an item is received in a fulfillment center in a form of a cross dock, a shortage cause occurring during the unloading, receiving, or stowing may be analyzed based on the time when the item is received in the first fulfillment center.

The fourth shortage cause according to some example embodiments may include the shortage cause due to the nature of the item in FIG. 3 and may include the shortage cause due to the nature of the item in FIG. 4, the shortage cause because the item is a new product, and the shortage cause due to the defect in the replenishment center.

The shortage due to the defect in the replenishment center may mean, for example, that an item shortage occurs due to delayed delivery, shipment, or the like of a replenishment center because the item is an item that needs to pass through the replenishment center (for example, frozen foods or the like). The item that needs to pass through the replenishment center may be received in the fulfillment center and then shipped, or the item received in the fulfillment center may be stored in and shipped from the replenishment center, and the item that needs to be shipped from the replenishment center may be an item that has been delivered insufficiently from the fulfillment center (short delivery) or has not been delivered from the fulfillment center (non-delivery). Similarly, the item to be shipped from the fulfillment center may be an item that has been delivered insufficiently from the replenishment center (short delivery) or has not been delivered from the replenishment center (non-delivery).

The fifth shortage cause according to some example embodiments may include the shortage cause due to the sales amount of the item in FIG. 3 and include the shortage cause due to the sales amount of the item in FIG. 4. The fifth shortage cause confirmation part 1500e according to some example embodiments may perform, for example, the operation illustrated in FIG. 13 to confirm whether the cause of the item shortage is the fifth shortage cause according to the example embodiments.

The sixth shortage cause according to some example embodiments may include the shortage cause due to the supplier in FIG. 3 and include the shortage cause due to the supplier in FIG. 4. The sixth shortage cause confirmation part 1500f according to some example embodiments may perform, for example, the operation illustrated in FIGS. 13 to 15 to confirm whether the cause of the item shortage is the sixth shortage cause according to the example embodiments.

The seventh shortage cause 307 according to some example embodiments may include the shortage cause due to the small order quantity in FIG. 3, and may include at least one of the shortage due to the supplier in FIG. 4 and the shortage cause due to the small order quantity. The sixth shortage cause confirmation part 1500f according to some example embodiments may perform, for example, the operation illustrated in FIG. 11 to confirm whether the cause of the item shortage is the sixth shortage cause according to the example embodiments.

The electronic apparatus according to some example embodiments may confirm the cause of the item shortage in the order of confirming the shortage cause determined based on the priority of the first shortage cause to the seventh shortage cause according to the example embodiments. That is, the electronic apparatus according to example embodiments may combine the first shortage cause confirmation part 1500a to the seventh shortage cause confirmation part 1500g according to some example embodiments in a specific order so that the cause of the item shortage may be understood in the order of confirming the shortage cause. The first shortage cause confirmation part 1500a to the seventh shortage cause confirmation part 1500g according to some example embodiments may confirm the cause of the item shortage based on the information on the item according to the example embodiments.

The information on the item may include, for example, the information indicating the order status of items by period, the fill rate of the item received from the supplier by period (or by order unit), the order information corresponding to the specific period of the item, the receiving-related information of the item, the unloading-related information of the item, the stow-related information of the item, the name of the item, the supplier supplying the item, the sales amount of the item by period, the information on the fulfillment center in which the item is stored, the information on the supplier (that is, information indicating a vendor of an item) when the item is ordered from and supplied by the supplier, the information on the order (for example, an order cycle, an order quantity per order, etc.), and the information indicating whether the item is the seasonal item, the season period of the item, and the social problem of the item. Furthermore, the information on the item may include, for example, the code life of the item and the average sales amount of the item by period. The information on the item may further include the minimum order quantity corresponding to the item, the unloading completion time of the item within the fulfillment center, the scheduled receiving time of the item, the unloading amount of the item, the confirmed quantity of the item, the unloading amount of the item and the stow amount of the item within the fulfillment center, and the maximum sales amount among the daily sales amounts of the item for the specific period, and the average sales amount indicating the average sales amount of the item for the specific period. The electronic apparatus according to some example embodiments may confirm the cause of the item shortage in the order of confirming the shortage cause determined based on the priority of the first shortage cause to the seventh shortage cause according to the example embodiments.

According to various example embodiments, it is possible for an electronic apparatus to accurately analyze the shortage cause by combining methods for analyzing various shortage causes in a specific order or a preset order, and confirming the shortage causes according to a priority, thereby preventing the item shortage in the future.

Meanwhile, the example embodiment of the present disclosure has been disclosed in the present specification and drawings, and although specific terms are used, these are merely used in a general sense to easily describe the technical content of the present disclosure and to aid understanding of the present disclosure but is not intended to limit the scope of the present disclosure. It is obvious to those of ordinary skill in the art to which the present disclosure pertains that other modifications based on the technical idea of the present disclosure may be implemented in addition to some example embodiments disclosed herein.

The electronic apparatus or terminal according to the above-described example embodiments may include a processor, a memory that stores and executes program data, a permanent storage such as a disk drive, a communication port that communicates with an external device, a touch panel, a key, a user interface device such as a button, and the like. Methods implemented as software modules or algorithms may be stored on a computer-readable recording medium as computer-readable code or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disc (CD)-ROM or a digital versatile disc (DVD)), and the like. The computer-readable recording medium may be distributed in computer systems connected to each other through a network, and as a result, the computer-readable code may be stored and executed in a distributed manner. The medium may be readable by a computer, stored in a memory, and executed on a processor.

The present example embodiment may be represented by functional block configurations and various processing operations. These functional blocks may be implemented by various numbers of hardware and/or software components that execute specific functions. For example, the example embodiment may employ integrated circuit configurations, such as a memory, processing, logic, and a look-up table, capable of executing various functions by control of one or more microprocessors or other control devices. Similar to executing the components with software programming or software elements, the present example embodiment may be implemented with programming or scripting languages such as C, C++, Java, Assembly, and Python including various algorithms implemented by a combination of data structures, processes, routines or other programming configurations. Functional aspects may be implemented with algorithms executed on one or more processors. In addition, the present example embodiment may employ a conventional technology for electronic environment setting, signal processing, and/or data processing, and the like. Terms such as “mechanism,” “element,” “means,” and “configuration” may be used broadly and are not limited to mechanical and physical configurations. The terms may include the meaning of a series of routines of software in connection with a processor or the like.

The above-described example embodiments are merely examples, and other example embodiments may be implemented within the scope of the following claims.

Meanwhile, some example embodiments of the present disclosure have been disclosed in the present specification and drawings, and although specific terms are used, these are merely used in a general sense to easily describe the technical content of the present disclosure and to aid understanding of the present disclosure but are not intended to limit the scope of the present disclosure. It is obvious to those of ordinary skill in the art to which the present disclosure pertains that other modifications based on the technical idea of the present disclosure may be implemented in addition to some example embodiments disclosed herein.

What is claimed is:

1. A method of providing information related to an item shortage by an electronic apparatus, the method comprising:
confirming information on an item of which a shortage occurs in a fulfillment center, the information on the item including an order status of the item;
confirming a cause of an item shortage based on the information on the item; and
providing information indicating the cause of the item shortage.

2. The method of claim 1, wherein the cause of the item shortage includes at least one of a first shortage cause related obsolescence by a vendor, a second shortage cause related to the order status of the item, a third shortage cause related to the fulfillment center, a fourth shortage cause related to a nature of the item, a fifth shortage cause due to a sales amount of the item, and a sixth shortage cause due to a small order quantity of the item.

3. The method of claim 2, wherein the confirming of the cause of the item shortage comprises confirming the first shortage cause to the sixth shortage cause in a confirmation order determined according to a priority.

4. The method of claim 2, wherein the confirming of the cause of the item shortage further comprises:
confirming information indicating a vendor of the item from the information on the item; and
determining the cause of the item shortage as the first shortage cause when the vendor has discontinued the item.

5. The method of claim 2, wherein the second shortage cause related to the order status of the item is determined based on information indicating the order status of the item acquired from the information on the item.

6. The method of claim 5, wherein the confirming of the cause of the item shortage further comprises determining the cause of the item shortage as the second shortage cause when the order status of the item for a day before a first date when the item shortage occurs is a discontinue status.

7. The method of claim 5, wherein the confirming of the cause of the item shortage further comprises determining the cause of the item shortage as the second shortage cause when the order status of the item for a second date before a specific period from a first date when the item shortage occurs is a discontinued status, and a scheduled receiving date for an order after the second date is after the first date.

8. The method of claim 5, wherein the confirming of the cause of the item shortage further comprises determining the cause of the item shortage as the second shortage cause when the order status of the item for a second date before a specific period from a first date when the item shortage occurs is a discontinued status, and there is no order for the item after the second date.

9. The method of claim 6, wherein the discontinue status includes a discontinued status based on the item being a seasonal item and a discontinued status based on the item being an item related to a social issue.

10. The method of claim 2, wherein the third shortage cause includes a first shortage sub-cause indicating a shortage due to a stock adjustment of the item and a second shortage sub-cause indicating a shortage related to a stowing delay of the item in the fulfillment center.

11. The method of claim 10, wherein the information on the item includes information indicating whether stock of the item has been adjusted within a specific period, and
the confirming of the cause of the item shortage further comprises determining the cause of the item shortage as the first shortage sub-cause when the stock of the item has been adjusted within the specific period.

12. The method of claim 10, wherein the information on the item includes a stow time of the item in the fulfillment center and an unloading time of the item in the fulfillment center, and
the confirming of the cause of the item shortage further comprises determining the cause of the item shortage as the second shortage sub-cause when a difference between the stow item and the unloading time is a specific time or more.

13. The method of claim 2, wherein the information on the item includes a first sales amount indicating a sales amount of the item for a first period, and a second sales amount indicating a sales amount of the item for a second period after the first period, and
the confirming of the cause of the item shortage further comprises determining whether the cause of the item shortage is the fifth shortage cause by calculating a ratio of the second sales amount to the first sales amount.

14. The method of claim 2, wherein the information on the item further includes a summed order quantity of the item, an order reduction amount of the item due to a capacity of the fulfillment center, and a fill rate of a supplier for the item, and
the confirming of the cause of the item shortage further comprises confirming whether the cause of the item shortage is the sixth shortage cause based on the order quantity and the fill rate of the item.

15. The method of claim 14, further comprising:
confirming a remaining acceptable quantity of the fulfillment center when the cause of the item shortage is the sixth shortage cause; and
determining an appropriate order quantity of the item based on the remaining acceptable quantity and the sales amount of the item.

16. The method of claim 1, wherein the information on the item includes the number of returns of the item and a received amount of the item within a specific period, and
the cause of the item shortage includes a seventh shortage cause which is a shortage cause due to a quality defect of the item.

17. The method of claim 16, wherein the confirming of the cause of the item shortage further comprises determining the cause of the item shortage as the seventh shortage cause when the number of returns of the item within the specific period is a specific number of times or more and the number of returns of the item is greater than or equal to a specific ratio of the received amount of the item.

18. The method of claim 1, further comprising:
reporting the information indicating the cause of the item shortage to a subject corresponding to the confirmed item shortage cause.

19. An electronic apparatus for providing information related to an item shortage, the electronic apparatus comprising:
a memory in which at least one program is stored; and
a processor configured to execute the at least one program to confirm a shortage of an item, confirm information on the item, confirm a cause of an item shortage based on the information on the item, and provide information indicating the cause of the item shortage.

20. A non-transitory computer-readable storage medium comprising:
a medium configured to store computer-readable instructions,
wherein when the computer-readable instructions are executed by a processor, the processor performs:
confirming a shortage of an item;
confirming information on the item
confirming a shortage cause of the item based on the information on the item; and
providing information indicating the shortage cause of the item.
